(19) United States
(12) Patent Application Publication
(10) Pub. No.: US 2024/0076526 A1
(43) Pub. Date: Mar. 7, 2024

(54) PHOTOCURABLE COMPOSITION HAVING SHEET SHAPE, PHOTOCURABLE COMPOSITION, METHOD FOR PRODUCING PHOTOCURABLE COMPOSITION HAVING SHEET SHAPE, AND LAMINATED BODY

(71) Applicant: THREEBOND CO., LTD., Tokyo (JP)

(72) Inventors: Ryota OKAYAMA, Tokyo (JP); Manabu INOUE, Tokyo (JP); Takashi NEMOTO, Tokyo (JP)

(73) Assignee: THREEBOND CO., LTD., Tokyo (JP)

(21) Appl. No.: 18/451,547

(22) Filed: Aug. 17, 2023

(30) Foreign Application Priority Data
Aug. 19, 2022 (JP) 2022-130982

(51) Int. Cl. C09J 7/38; C09J 7/10; C09J 7/40; C09J 11/06

(52) U.S. Cl. CPC C09J 7/38; C09J 7/10; C09J 7/405; C09J 11/06; C09J 2203/326; C09J 2301/408; C09J 2301/416; C09J 2400/28; C09J 2475/00

(57) ABSTRACT

The present invention relates to a photocurable composition having a sheet shape at 25° C. in an uncured state, the photocurable composition including a urethane-modified (meth)acrylate oligomer and a photoinitiator and being free from a film-forming component. The present invention also relates to a photocurable composition, a method for producing a photocurable composition having a sheet shape at 25° C. in an uncured state, and a laminated body.

### CROSS-REFERENCE TO RELATED APPLICATIONS

This application claims priority from Japanese Patent Application No. 2022-130982 filed on Aug. 19, 2022, the entire subject matter of which is incorporated herein by reference.

### TECHNICAL FIELD

The present invention relates to a photocurable composition having a sheet shape at 25° C. in an uncured state.

### BACKGROUND ART

In the case where an object and a curved adherend are adhered as described in JP2018-42750A, a tackiness agent or the like is used. However, it has been known that the tackiness agent is peeled from the adherend due to springback caused by a change of the shape of the adherend when bonding an object and an adherend.

In particular, in the case where the adherend is plastic or the like which is hard to be adhered, the tackiness agent is easily peeled, and in the case where the shape of the adherend easily changes, the tackiness agent is more easily peeled.

Conventionally, in the case where an object and a curved adherend are bonded, it has been difficult to follow a change in the adherend.

### SUMMARY OF INVENTION

As a result of intensive studies to achieve the object, the present inventors have found out a photocurable composition that has tackiness before curing and that adheres after curing, and completed the present invention.

Next, the summary of the present invention will be described.
A first embodiment of the present invention is a photocurable composition having a sheet shape at 25° C. in an uncured state, the photocurable composition including:
a component (A); and
a component (B), in which
the photocurable composition is free from a film-forming component,
the component (A) is a urethane-modified (meth)acrylate oligomer synthesized from a component (A-1), a component (A-2) and a component (A-3),
   the component (A-1) is a polyol represented by the following general formula 1,
   the component (A-2) is a polyisocyanate compound, and
   the component (A-3) is a (meth)acrylate having a hydroxy group within a molecule, and
the component (B) is a photoinitiator.

A second embodiment of the present invention is the photocurable composition according to the first embodiment, in which the component (A) has a weight average molecular weight of 1,000 to 50,000, and
the component (A) has 1 to 4 (meth)acryloyl groups within one molecule.

A third embodiment of the present invention is the photocurable composition according to the first embodiment, in which the component (A-2) is an isophorone diisocyanate.

A fourth embodiment of the present invention is the photocurable composition according to the first embodiment, consisting of the component (A) and the component (B).

A fifth embodiment of the present invention is the photocurable composition according to the first embodiment, further including a component (C) being at least one component selected from the group consisting of a coupling agent, a (meth)acrylate monomer, and a (meth)acrylamide monomer, and consisting of the component (A), the component (B), and the component (C).

A sixth embodiment of the present invention is the photocurable composition according to the fifth embodiment, having a content of the component (C) of 0.1 parts by mass to 15 parts by mass based on 100 parts by mass of the component (A).

A seventh embodiment of the present invention is a photocurable composition including:
a component (A);
a component (B); and
a solvent, in which
the component (A) is a urethane-modified (meth)acrylate oligomer synthesized from a component (A-1), a component (A-2) and a component (A-3),
   the component (A-1) is a polyol represented by the following general formula 1,
   the component (A-2) is a polyisocyanate compound, and
   the component (A-3) is a (meth)acrylate having a hydroxy group within a molecule, and
the component (B) is a photoinitiator.

An eighth embodiment of the present invention is a method for producing a photocurable composition having a sheet shape at 25° C. in an uncured state, the method including:

volatilizing a solvent from a photocurable composition, in which the photocurable composition comprises:
a component (A);
a component (B); and the solvent, in which
the component (A) is a urethane-modified (meth)acrylate oligomer synthesized from a component (A-1), a component (A-2) and a component (A-3),
   the component (A-1) is a polyol represented by the following general formula 1,
   the component (A-2) is a polyisocyanate compound, and
   the component (A-3) is a (meth)acrylate having a hydroxy group within a molecule, and
the component (B) is a photoinitiator.

A ninth embodiment of the present invention is the method according to the eighth embodiment, in which the solvent is volatilized on a release paper or on a release film.

A tenth embodiment of the present invention is a laminated body including:
the photocurable composition according to the first embodiment; and
a release paper or a release film.

The first embodiment of the present invention is a photocurable composition having tackiness before curing, tackiness after curing, and a sheet shape at 25° C. in an uncured state. In the case where an object and a curved adherend are bonded, the photocurable composition according to the first embodiment of the present invention can follow a change in the adherend.

### DESCRIPTION OF EMBODIMENTS

Next, the present invention will be described in detail. In the present specification, the term “the photocurable composition of the present invention” can include each of the photocurable compositions according to the above embodiments.
The photocurable composition according to the first embodiment of the present invention includes a component (A) and a component (B) described below and is free from a film-forming component.

The component (A) is a urethane-modified (meth)acrylate oligomer synthesized from a component (A-1), a component (A-2) and a component (A-3) described below. A weight average molecular weight of the component (A) is preferably 1,000 to 50,000 and more preferably 5,000 to 45,000.

The weight average molecular weight refers to a value measured by, for example, gel permeation chromatography (GPC) using polystyrene as a standard substance. In addition, it is preferable that the component (A) have 1 to 4 (meth)acryloyl groups within one molecule, and it is most preferable that the component (A) have 2 to 4 (meth)acryloyl groups within one molecule. It is further preferable that the component (A) have an acryloyl group. Hereinafter, an acryloyl group and a methacryloyl group are also collectively referred to as a (meth)acryloyl group, and a compound including a (meth)acryloyl group is also referred to as a (meth)acrylate.

The component (A-1) is a polyol represented by General Formula 1 below. In General Formula 1, R¹ and R² are each independently a hydrogen atom or a monovalent hydrocarbon group, R³ and R⁴ are each independently a divalent hydrocarbon group having three or more carbon atoms, and n and m are each independently an integer of 1 or more.

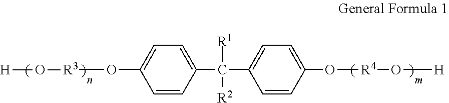

The component (A) can also be synthesized using, in addition to the component (A-1), another polyol other than the component (A-1). Specific examples of the polyol other than the component (A-1) include a polyether polyol, a polyester polyol, a caprolactone diol, a bisphenol polyol, a polyisoprene polyol, a hydrogenated polyisoprene polyol, a polybutadiene polyol, a hydrogenated polybutadiene polyol, a castor oil polyol, and a polycarbonate diol. Among them, a polycarbonate diol, a polybutadiene polyol, and a hydrogenated polybutadiene polyol are preferable from the viewpoints of an excellent transparency and an excellent durability. It is most preferable that only the component (A-1) be used as a polyol.

The component (A-2) is a polyisocyanate compound. The polyisocyanate compound refers to a compound having two or more isocyanate groups within a molecule. Specific examples of the polyisocyanate compound include an aromatic polyisocyanate, an alicyclic polyisocyanate, and an aliphatic polyisocyanate.

Examples of the aromatic polyisocyanate include trilene-2,4-diisocyanate, trilene-2,6-diisocyanate, 1,3-xylylene diisocyanate, 1,4-xylylene diisocyanate, tetramethylxylylene diisocyanate, diphenylmethane diisocyanate, naphthalene-1,5-diisocyanate, and triphenylmethane triisocyanate. Examples of the alicyclic polyisocyanate include isophorone diisocyanate, bis(4-isocyanatocyclohexyl)methane, 1,3-bis(isocyanatomethyl)cyclohexane, 1,4-bis(isocyanatomethyl)cyclohexane, norbornane diisocyanate, and bicycloheptane triisocyanate. Examples of the aliphatic polyisocyanate include hexamethylene diisocyanate, 1,3,6-hexamethylene triisocyanate, and 1,6,11-undeca triisocyanate.

These compounds may be used singly or may be used in combination. Among them, isophorone diisocyanate is most preferable from the viewpoint of a good film formability of the component (A).

The component (A-3) is a (meth)acrylate having a hydroxy group within a molecule. A (meth)acrylate having one or more hydroxy groups within one molecule can be used.
Examples of the (meth)acrylate having a hydroxy group within a molecule include a mono(meth)acrylate of a divalent alcohol such as 2-hydroxyethyl (meth)acrylate, hydroxypropyl (meth)acrylate, ethylene glycol, propylene glycol, 1,3-propanediol, 1,3-butanediol, 1,4-butanediol, and polyethylene glycol; and a mono(meth)acrylate or di(meth)acrylate of a trivalent alcohol such as trimethylolethane, trimethylolpropane, and glycerin.

These compounds may be used singly or may be used in combination. Among them, 2-hydroxyethyl (meth)acrylate is most preferable from the viewpoint of a good film formability of the component (A).

A synthesis method of the component (A) is not particularly limited, and a known method can be used. For example, a polyol compound having two or more hydroxy groups within a molecule and an polyisocyanate compound having two or more isocyanate groups within a molecule are reacted, preferably at a mole ratio (polyol compound: isocyanate compound) of 3:1 to 1:3 and more preferably at a mole ratio (polyol compound: isocyanate compound) of 2:1 to 1:2, in a diluent (for example, methyl ethyl ketone, methoxy phenol, or the like) to obtain a urethane prepolymer.

Then, isocyanate groups remaining in the obtained urethane prepolymer and a (meth)acrylate having at least one or more hydroxy groups within a molecule in an amount sufficient to react with the isocyanate groups are further reacted, and a urethane-modified (meth)acrylate oligomer can thus be synthesized.

Examples of a catalyst used during synthesis include lead oleate, tetrabutyltin, antimony trichloride, triphenylaluminum, trioctylaluminum, dibutyltin dilaurate, copper naphthenate, zinc naphthenate, zinc octylate, zinc octenoate, zirconium naphthenate, cobalt naphthenate, tetra-n-butyl-1,3-diacetyloxydistannoxane, triethylamine, 1,4-diaza[2.2.2]bicyclooctane, and N-ethylmorpholine. Among them, dibutyltin dilaurate, zinc naphthenate, zinc octylate, and zinc octenoate are preferable from the viewpoints of obtaining a cured product having a high activity and an excellent transparency.

These catalysts are preferably used in an amount of 0.0001 parts by mass to 10 parts by mass based on 100 parts by mass of reactants in total. A reaction temperature is usually 10° C. to 100° C., and preferably 30° C. to 90° C. The component (A) may be diluted with, for example, a solvent or (meth)acrylate monomers described later prior to start of synthesis.

The component (B) is a photoinitiator. Any compounds that are decomposed upon light irradiation with energy lines such as ultraviolet rays or visible light to generate radical species can be used as the component (B). Examples of the component (B) include an acetophenone photoinitiator, a benzoin photoinitiator, a benzophenone photoinitiator, a thioxanthone photoinitiator, and an acylphosphine oxide photoinitiator. These compounds may be used singly, or two or more kinds thereof may be used in combination. The component (B) preferably includes an acylphosphine oxide photoinitiator since photocurability is enhanced even with light irradiation at a low illumination level or a small accumulated light amount.

Examples of the acetophenone photoinitiator include, but are not limited to, diethoxy acetophenone, 2-hydroxy-2-methyl-1-phenylpropane-1-one, benzyl dimethyl ketal, 4-(2-hydroxyethoxy)phenyl-(2-hydroxy-2-propyl)ketone, 1-hydroxycyclohexyl phenyl ketone, 2-methyl-2-morpholino(4-thiomethylphenyl)propane-1-one, 2-benzyl-2 -dimethylamino-1-(4-morpholinophenyl)butanone, and a 2-hydroxy-2-methyl-1-[4-(1 -methylvinyl)phenyl]propanone oligomer.

Examples of the benzoin photoinitiator include, but are not limited to, benzoin, benzoin methyl ether, benzoin ethyl ether, benzoin isopropyl ether, and benzoin isobutyl ether.

Examples of the benzophenone photoinitiator include, but are not limited to, benzophenone, methyl o-benzoylbenzoate, 4-phenylbenzophenone, 4-benzoyl-4′-methyl-diphenyl sulfide, 3,3′,4,4′-tetra(t-butylperoxycarbonyl)benzophenone, and 2,4,6-trimethylbenzophenone.

Examples of the thioxanthone photoinitiator include, but are not limited to, 2-isopropylthioxanthone, 4-isopropylthioxanthone, 2,4-diethylthioxanthone, 2,4-dichlorothioxanthone, 1-chloro-4-propoxythioxanthone, and 2-(3-dimethylamino-2-hydroxy) -3,4-dimethyl-9H-thioxanthone-9-onmethochloride.

Examples of the acylphosphine oxide photoinitiator include, but are not limited to, bis(2,4,6-trimethylbenzoyl)-phenylphosphine oxide, 2,4,6-trimethylbenzoyl-diphenylphosphine oxide, and 2,4,6-trimethlybenzoylphenylethoxyphosphine oxide.

It is preferable that the photocurable composition according to the first embodiment of the present invention consist of only the component (A) and the component (B) from the viewpoints of shape maintainability and transfer performance. An addition amount of the component (B) based on 100 parts by mass of the component (A) is preferably 0.1 parts by mass to 5.0 parts by mass, more preferably 1.0 parts by mass to 4.0 parts by mass, and peculiarly preferably 1.0 parts by mass to 3.0 parts by mass. In the case where the addition amount of the component (B) is 0.1 parts by mass or more, photocurability is easily exhibited, and in the case where the addition amount of the component (B) is 5.0 parts by mass or less, a cured product is less likely to be colored.

The photocurable composition of the present invention may further include, as a component (C), at least one component selected from the group consisting of a coupling agent, a (meth)acrylate monomer, and a (meth)acrylamide monomer. In the case where the photocurable composition of the present invention includes the component (C), it is preferable that the photocurable composition of the present invention consist of only the component (A), the component (B) and the component (C) from the viewpoints of shape maintainability and transfer performance. At that time, the component (C) can be added in an amount of 0.1 parts by mass to 15 parts by mass based on 100 parts by mass of the component (A). Improvement in adhesive force and improvement in durability can be achieved by adding the component (C) within the range. The coupling agent and the (meth)acrylate monomer are both liquid at 25° C. In the case where a component which is liquid at 25° C. is added to the component (A), it is preferable that the component which is liquid at 25° C. be selected only from the coupling agent and the (meth)acrylate monomer.

Examples of the coupling agent usable in the present invention include a silane coupling agent. Specific examples of the silane coupling agent include glycidyl group-containing silane coupling agents such as 2-(3,4-epoxycyclohexyl)ethyltrimethoxysilane, 3-glycidoxypropyltriethoxysilane, 3-glycidoxypropylmethyldimethoxysilane, 3-glycidoxypropyltrimethoxysilane, and 3-glycidoxypropylmethyldiethoxysilane; vinyl group-containing silane coupling agents such as vinyltris((β-methoxyethoxy)silane, vinyltriethoxysilane, and vinyltrimethoxysilane; (meth)acryloyl group-containing silane coupling agents such as y-methacryloxypropyltrimethoxysilane; amino group-containing silane coupling agents such as N-β-(aminoethyl)-γ-aminopropyltrimethoxysilane, γ-aminopropyltriethoxysilane, and N-phenyl-γ-aminopropyltrimethoxysilane; and other coupling agents such as γ-mercaptopropyltrimethoxysilane, and γ-chloropropyltrimethoxysilane. These coupling agents may be used singly, or two or more kinds thereof may be used in combination. Among them, a silane coupling agent having an epoxy group or a (meth)acryloyl group is preferably used from the viewpoint that improvement in tightness can be further expected.

Examples of the (meth)acrylate monomer (except for the component (A)) usable in the present invention include a monofunctional (meth)acrylate monomer, a bifunctional (meth)acrylate monomer, a trifunctional (meth)acrylate monomer, and a tetrafunctional (meth)acrylate monomer and (meth)acrylate monomers with higher functionality. A bifunctional (meth)acrylate monomer is preferable as the (meth)acrylate monomer. A molecular weight of each of the (meth)acrylate monomer and the (meth)acrylamide monomer is preferably 10,000 or less, more preferably 5,000 or less, and most preferably 1,000 or less in order to decrease the viscosity of the composition.

Examples of the monofunctional (meth)acrylate monomer include lauryl (meth)acrylate, stearyl (meth)acrylate, tetrahydrofurfuryl (meth)acrylate, caprolactone-modified tetrahydrofurfuryl (meth)acrylate, cyclohexyl (meth)acrylate, dicyclopentanyl (meth)acrylate, isobornyl (meth)acrylate, benzyl (meth)acrylate, phenyl (meth)acrylate, phenoxyethyl (meth)acrylate, phenoxydiethylene glycol (meth)acrylate, phenoxytetraethylene glycol (meth)acrylate, nonylphenoxyethyl (meth)acrylate, butoxyethyl (meth)acrylate, 2-hydroxyethyl (meth)acrylate, 2-hydroxypropyl (meth)acrylate, glycerol (meth)acrylate, modified butyl (meth)acrylate, epichlorohydrin-modified phenoxy (meth)acrylate, N,N-dimethylaminoethyl (meth)acrylate, N,N-diethyl aminoethyl (meth)acrylate, and morpholino (meth)acrylate.

Examples of the bifunctional (meth)acrylate monomer include neopentyl glycol di(meth)acrylate, polyethylene glycol di(meth)acrylate, bisphenol A di(meth)acrylate, epichlorohydrin-modified bisphenol A di(meth)acrylate, stearic acid-modified pentaerythritol di(meth)acrylate, dicyclopentenyl di(meth)acrylate, and di(meth)acryloyl isocyanurate.

Examples of the trifunctional (meth)acrylate monomer include trimethylolpropane tri(meth)acrylate, pentaerythritol tri(meth)acrylate, epichlorohydrin-modified trimethylolpropane tri(meth)acrylate, and epichlorohydrin-modified glycerol tri(meth)acrylate.

Examples of the tetrafunctional (meth)acrylate monomer and (meth)acrylate monomers with higher functionality include ditrimethylolpropane tetra(meth)acrylate, pentaerythritol tetra(meth)acrylate, dipentaerythritol monohydroxy penta(meth)acrylate, alkyl-modified dipentaerythritol penta(meth)acrylate, and dipentaerythritol hexa(meth)acrylate. These polymerizable monomers may be used singly, or two or more kinds thereof may be mixed and used.

Specific examples of the (meth)acrylamide monomer include, but are not limited to, dimethyl(meth)acrylamide, (meth)acryloylmorpholine, and diethyl(meth)acrylamide. Although a clear cause thereof is not sure, the monomer of the component (C) preferably includes the (meth)acrylamide monomer from the viewpoint of improving durability. As specific examples of the (meth)acrylamide monomer in the present invention, DMAA, ACMO, DEAA, and the like manufactured by KJ Chemicals Corporation are known, but the (meth)acrylamide monomer is not limited thereto.

As the (meth)acrylate monomer, a (meth)acrylate having an ether bond and a

(meth)acryloyl group is preferable, and a polyether monomer having 8 to 30 ether bond repeat structures within one molecule is most preferable. The polyether monomer in which the number of ether bond repeat structures is 8 or more is separated from moisture penetrating, from the outside, into the inside of a cured product in a high-temperature and high-humidity atmosphere and does not get cloudy. Meanwhile, in the polyether monomer in which the number of ether bond repeat structures is 30 or less, monomers do not crystalize together, and a cured product does not get cloudy. These monomers may be used singly or may be used in combination.

Examples of the (meth)acrylate having an ether bond and a (meth)acryloyl group include polyethylene glycol mono(meth)acrylate, polyethylene glycol di(meth)acrylate, polypropylene glycol mono(meth)acrylate, polypropylene glycol di(meth)acrylate, polyoxytetramethylene glycol mono(meth)acrylate, and polyoxytetramethylene glycol di(meth)acrylate.

A molecular weight of the (meth)acrylate having an ether bond and a (meth)acryloyl group is preferably 200 to 5,000 and more preferably 250 to 3,000.

Specific examples of the (meth)acrylate having an ether bond and a (meth)acryloyl group include, but are not limited to, NK ester 14G, M-90G, AM-130G, M-230G, A-400, A-600, APG-700, A-1000, 9G, 14G, 23G, and 1206PE manufactured by SHIN-NAKAMURA CHEMICAL Co., Ltd.; PDE-600, PDP-700, and ADE-600 manufactured by NOF CORPORATION; and light ester series of 130MA, 130A, 14EG, and 14EG-A manufactured by Kyoeisha Chemical Co., Ltd.

The photocurable composition according to the first embodiment of the present invention does not include a film forming component (provided that the components (A) to (C) are excluded). In addition, it is preferable that the photocurable composition according to the seventh embodiment of the present invention do not include a film forming component. In the case where a film forming component is added to the component (A), the photocurable composition according to the first embodiment of the present invention becomes excessively hard, and an initial tackiness cannot be exhibited. Examples of the film forming component include elastomers and thermoplastic resins which are solid at 25° C. and have a skeleton in which the same structure is repeated. Specific examples of the film forming component include an epoxy resin, a phenoxy resin, a (meth)acrylic polymer, a polyester resin, and a urethane elastomer which are solid at 25° C.

Additives such as a solvent, a filler such as an inorganic filler and an organic filler, a storage stabilizer, an antioxidant, a photostabilizer, an ultraviolet absorber, a plasticizer, a dye, a pigment, a flame retardant, a sensitizer, a thermal initiator, a heavy metal deactivator, an ion trapping agent, an emulsifier, a water dispersion stabilizer, a defoaming agent, a mold-release agent, a leveling agent, a wax, a rheology controlling agent, and a surfactant may be blended, as other components, in the present invention within a range not impairing the purpose of the present invention.

In the present invention, a photocurable composition having a sheet shape at 25° C. in an uncured state can be produced by volatilizing a solvent from the photocurable composition according to the seventh embodiment of the present invention that includes the component (A), the component (B), and the solvent.

Examples of the solvent include alcohols such as methanol and ethanol; chlorine solvents such as dichloroethane and trichloroethane; fluoride solvents such as trichlorofluoroethane; ketone solvents such as acetone, methyl ethyl ketone, and methyl isobutyl ketone; ester solvents such as methyl acetate, ethyl acetate, propyl acetate, and butyl acetate; ethers such as dimethyl ether and methyl ethyl ether; hydrocarbon solvents such as pentane, hexane, heptane, and cyclohexane; and aromatic solvents such as benzene, toluene, and xylene. The ketone solvents are preferable in view of compatibility with the above-described other components.

In addition, volatile components such as the solvent are volatilized through heating during a sheeting step. Even in the case where a trace amount of the solvent and the like remains after volatilizing the solvent and the like through heating, the composition having a sheet shape is interpreted as including no solvent and the like.

Specific examples of the inorganic filler include a glass powder, a fumed silica powder, a silica powder, an alumina powder, a mica powder, a silicone rubber powder, a calcium carbonate powder, an aluminum nitride powder, a carbon powder, a kaolin clay powder, a dried clay mineral powder, a dried diatomaceous earth powder, and a metal powder.

Furthermore, examples of the fumed silica powder include those having surfaces chemically modified (hydrophobized) with organochlorosilanes, polyorganosiloxane, hexamethyldisilazane, or the like. Specific examples thereof include commercially available AEROSIL series of R974, R972, R972V, R972CF, R805, R812, R812S, R816, R8200, RY200, RX200, RY200S, and R202 manufactured by NIPPON AEROSIL CO., LTD. The inorganic filler can be added for the purpose of improving flowability and the like and enhancing mechanical strength of a cured product.

Examples of the ultraviolet absorber include, but not limited to, 2-(5-chloro-2-benzotriazolyl)-6-tert-butyl-p-cresol, 2-(2′-hydroxy-5′-tert-octylphenyl)benzotriazole, 2-(2′-hydroxy-3′-tert-butyl-5′-methylphenyl)-5-chlorobenzotriazole, 2-(3,5-di-tert-amyl-2-hydroxyphenyl)benzotriazole, 1,2,3,4-butanetetracarboxylic acid tetrakis(1,2,2,6,6-pentamethylpiperidine-4-yl), bis(2,2,6,6-tetramethyl-4-piperidyl)sebacate, and bis(1,2,2,6,6-pentamethyl-4-piperidyl)sebacate.

Specific examples of the ultraviolet absorber include, but not limited to, Adekastab LA-52, LA-57, LA-63P, LA-68, LA-72, LA-77Y, and LA-77G manufactured by ADEKA Corporation; and JF-90 and JF-95 manufactured by Johoku Chemical Co.,Ltd.

Known technology can be used as a method for obtaining the photocurable composition having a sheet shape. For example, a stock solution with a viscosity thereof intentionally decreased by adding a solvent to the photocurable composition is prepared, the stock solution is applied to a release film having a surface preliminarily subjected to a release treatment, and the solvent is subsequently volatilized to process the photocurable composition into a sheet shape. The photocurable composition having a sheet shape at 25° C. in an uncured state is obtained thereby. The solvent may be volatilized not only on a release film but on a release paper. A laminated body including the photocurable component, and a release paper or a release film is obtained in such a manner.
In addition, a release film may be bonded to one side or both sides of the photocurable composition having a sheet shape.

Examples of a method for applying the stock solution to a release film include a flow coating method, a roll coating method, a gravure roll method, a wire bar method, and a lip die coating method.
In addition, a hot air drying furnace, an IR furnace, and the like can be used as a drying device in the solvent volatilizing step.

Examples of material for the release film include plastic films such as a polyethylene film, a polypropylene film, a polyethylene terephthalate film, and a polyester film, paper, cloth, and unwoven fabric, but the plastic films are preferable from the viewpoint of releasability.
A thickness of the release film is preferably 5 μm to 300 μm and more preferably 25 μm to 200 μm.

The release film is preferably subjected to a release treatment with a fluorine compound, a silicone compound, a long chain alkyl compound, or the like.

Since the photocurable composition having a sheet shape at 25° C. in an uncured state according to the present invention exhibits tackiness, it is preferable that the release film be present on both sides of the photocurable composition having a sheet shape, and two types of the release film preferably have different releasability.

The photocurable composition of the present invention can be cured through irradiation with energy lines such as ultraviolet light and visible light. Irradiation light in the wavelength range of 150 nm to 750 nm is preferable. The photocurable composition of the present invention can be cured with an accumulated light amount of 1 kJ/m² to 100 kJ/m² using a low pressure mercury lamp, a medium pressure mercury lamp, a high pressure mercury lamp, an ultra-high pressure mercury lamp, a xenon lamp, a metal halide lamp, or an LED lamp. The accumulated light amount is preferably 5 kJ/m² to 70 kJ/m^{2 .}

The photocurable composition of the present invention can be used to assemble a display device such as a liquid crystal display and an organic EL display. Specifically, the photocurable composition of the present invention is suitable for assembling a display element, a cover panel, a touch panel, a VR goggle, and the like into a display device and assembling an organic EL element itself.

Various members are compositely used as members for assembling them. Examples thereof include an untreated PET without a surface treatment such as a corona treatment, a surface treated PET, a glass plate, an acrylic plate, and a polycarbonate plate, and these members are further adhered in various combinations.

A step of adhering two transparent adherends using a photocurable composition having a sheet shape in which release films are bonded to both sides of the photocurable composition will be described below.

The adhesion step includes a lamination step and a curing step.
In the lamination step, a release film with a high releasability is peeled from the photocurable composition, and the photocurable composition is attached to one adherend. In such a state, the photocurable composition and one adherend are bonded while pressurizing the same with a laminator. Thereafter, a release film with a low releasability is peeled from the photocurable composition, and the other adherend is bonded to the photocurable composition with a laminator in the same manner.

Finally, the two adherends can be adhered by curing the photocurable composition having a sheet shape through irradiation with energy lines.

A vacuum pressing machine or a vacuum laminator capable of bonding the photocurable composition and adherends in vacuum or in a reduced pressure atmosphere, or an autoclave can be used instead of the laminator, for example.

The adhesion step is not limited thereto.

### EXAMPLES

Next, the present invention will be described in more detail with reference to examples, but the present invention is not limited to the examples. Hereinafter, a photocurable composition having a sheet shape at 25° C. in an uncured state that is obtained by volatilizing a solvent is simply referred to as a sheet-shaped composition, and a photocurable composition including a solvent is simply referred to as a stock solution.

### EXAMPLES 1 TO 5 AND COMPARATIVE EXAMPLES 1 TO 6

The following components for preparing each stock solution were prepared.

### Component (A): a Urethane-Modified (Meth)Acrylate Oligomer Synthesized from Components (A-1), (A-2) and (A-3) Below

### Synthesis 1

To a reaction chamber, were added 240 g of bisphenol A propylene oxide-modified polyol (number average molecular weight: about 800) as the component (A-1), 74 g of isophorone diisocyanate as the component (A-2), 7 g of 2-hydroxyethyl acrylate as the component (A-3), 0.8 g of dibutyltin dilaurate as a urethanization catalyst, 0.2 g of 2,6-di-tert-butyl-p-cresol as a polymerization inhibitor, and 175 g of methyl ethyl ketone as a synthesis solvent, followed by stirring at 70° C. for about 16 hours. As a result, Synthetic Product 1 (the number of (meth)acrylate functional groups: 2, weight average molecular weight: 40,000) was obtained.

### Synthesis 2

To a reaction chamber, were added 288 g of bisphenol A propylene oxide-modified polyol (number average molecular weight: about 800) as the component (A-1), 95 g of isophorone diisocyanate as the component (A-2), 17 g of 2-hydroxyethyl acrylate as the component (A-3), 0.4 g of dibutyltin dilaurate as a urethanization catalyst, 0.2 g of 2,6-di-tert-butyl-p-cresol as a polymerization inhibitor, and 100 g of methyl ethyl ketone as a synthesis solvent, followed by stirring at 70° C. for about 16 hours. As a result, Synthetic Product 2 (the number of (meth)acrylate functional groups: 2, weight average molecular weight: 20,000) was obtained.

### Synthesis 3

To a reaction chamber, were added 273 g of bisphenol A propylene oxide-modified polyol (number average molecular weight: about 800) as the component (A-1), 100 g of isophorone diisocyanate as the component (A-2), 26 g of 2-hydroxyethyl acrylate as the component (A-3), 0.4 g of dibutyltin dilaurate as a urethanization catalyst, 0.2 g of 2,6-di-tert-butyl-p-cresol as a polymerization inhibitor, and 100 g of methyl ethyl ketone as a synthesis solvent, followed by stirring at 70° C. for about 16 hours. As a result, Synthetic Product 3 (the number of (meth)acrylate functional groups: 2, weight average molecular weight: 10,000) was obtained.

### Synthesis 4

To a reaction chamber, were added 292 g of bisphenol A propylene oxide-modified polyol (number average molecular weight: about 800) as the component (A-1), 96 g of isophorone diisocyanate as the component (A-2), 11 g of n-butanol as the component (A-3), 0.8 g of dibutyltin dilaurate as a urethanization catalyst, 0.2 g of 2,6-di-tert-butyl-p-cresol as a polymerization inhibitor, and 100 g of methyl ethyl ketone as a synthesis solvent, followed by stirring at 70° C. for about 16 hours. As a result, Synthetic Product 4 (the number of (meth)acrylate functional groups: 0, weight average molecular weight: 20,000) was obtained.

### Synthesis 5

To a reaction chamber, were added 227 g of bisphenol A propylene oxide-modified polyol (number average molecular weight: about 800) as the component (A-1), 69 g of isophorone diisocyanate as the component (A-2), 4 g of n-butanol as the component (A-3), 0.6 g of dibutyltin dilaurate as a urethanization catalyst, 0.2 g of 2,6-di-tert-butyl-p-cresol as a polymerization inhibitor, and 200 g of methyl ethyl ketone as a synthesis solvent, followed by stirring at 70° C. for about 16 hours. As a result, Synthetic Product 5 (the number of (meth)acrylate functional groups: 0, weight average molecular weight: 40,000) was obtained.

### Synthesis 6

To a reaction chamber, were added 304 g of bisphenol A propylene oxide-modified polyol (number average molecular weight: about 800) as the component (A-1), 95 g of isophorone diisocyanate as the component (A-2), 0.6 g of dibutyltin dilaurate as a urethanization catalyst, 0.2 g of 2,6-di-tert-butyl-p-cresol as a polymerization inhibitor, and 100 g of methyl ethyl ketone as a synthesis solvent, followed by stirring at 70° C. for about 16 hours. As a result, Synthetic Product 6 (the number of (meth)acrylate functional groups: 0, weight average molecular weight: 2,400) was obtained.

### Synthesis 7

Bisphenol A propylene oxide-modified polyol in Synthesis 1 was changed to polypropylene glycol (number average molecular weight: about 2,000), and no synthesis solvent was used, thereby obtaining Synthetic Product 7 (the number of (meth)acrylate functional groups: 2, weight average molecular weight: 20,000).

### Synthesis 8

Bisphenol A propylene oxide-modified polyol in Synthesis 1 was changed to bis phenol A ethylene oxide-modified polyol (number average molecular weight: about 500), thereby obtaining Synthetic Product 8 (the number of (meth)acrylate functional groups: 2, weight average molecular weight: 26,000).

### Component (B): Photoinitiator

2,4,6-Trimethylbenzoyl-diphenylphosphine oxide (IRGACURE TPO, manufactured by BASF SE)

### Component (C): Coupling Agent

3-Methacryloxypropyltrimethoxysilane (KBM-503, manufactured by Shin-Etsu Chemical Co., Ltd.)

### Component (C): (Meth)Acrylate Monomer

Polyethylene glycol #600 dimethacrylate (repetition of ethylene glycol: n=14) (NK Ester 14G, manufactured by SHIN-NAKAMURA CHEMICAL Co., Ltd.)

Film Forming Component
Solution of phenoxy resin in methyl ethyl ketone with a solid content of 50% by mass (YP-70 (phenoxy resin), manufactured by NIPPON STEEL Chemical & Material Co., Ltd.)
The amount shown in Table 1 is the solid content in terms of parts by mass, and methyl ethyl ketone used for dissolution is included in the solvent described below.

### Solvent

Methyl ethyl ketone (reagent)

The component (A) (or component (A′)) and the solvent (including the film forming component in Comparative Example 6) were weighed, placed in a stirring chamber, and stirred in an atmosphere of 25° C. for one hour. In the case where methyl ethyl ketone volatilized, methyl ethyl ketone in an amount equal to the volatilized amount was added. Next, the other components were added, and the mixture was further stirred for 30 minutes. As a result, each stock solution was obtained. Detailed preparation amounts are shown in Table 1, and the numerical values therein are all represented by parts by mass.

TABLE 1

| Component | Raw material | Example 1 | Example 2 | Example 3 | Example 4 | Example 5 |
|---|---|---|---|---|---|---|
| Component (A) | Synthetic | 100 | 100 | | | 100 |
| | Product 1 | | | | | |
| | Synthetic | | | 100 | | |
| | Product 2 | | | | | |
| | Synthetic | | | | 100 | |
| | Product 3 | | | | | |
| Component (A′) | Synthetic | | | | | |
| | Product 4 | | | | | |
| | Synthetic | | | | | |
| | Product 5 | | | | | |
| | Synthetic | | | | | |
| | Product 6 | | | | | |
| | Synthetic | | | | | |
| | Product 7 | | | | | |
| | Synthetic | | | | | |
| | Product 8 | | | | | |
| Component (B) | TPO | 2 | 2 | 2 | 2 | 2 |
| Component (C) | KBM-503 | | 1 | | | |
| | 14G | | | | | 10 |
| Film forming | YP-70 | | | | | |
| component | | | | | | |
| Solvent | Methyl ethyl | 50 | 50 | 50 | 50 | 50 |
| | ketone | | | | | |

| | | | | | |
|---|---|---|---|---|---|
| Total | 152 | 153 | 152 | 152 | 162 |

| | | Comparative | Comparative | Comparative | Comparative | Comparative | Comparative |
|---|---|---|---|---|---|---|---|
| Component | Raw material | Example 1 | Example 2 | Example 3 | Example 4 | Example 5 | Example 6 |
| Component (A) | Synthetic | | | | | | 100 |
| | Product 1 | | | | | | |
| | Synthetic | | | | | | |
| | Product 2 | | | | | | |
| | Synthetic | | | | | | |
| | Product 3 | | | | | | |
| Component (A′) | Synthetic | 100 | | | | | |
| | Product 4 | | | | | | |
| | Synthetic | | 100 | | | | |
| | Product 5 | | | | | | |
| | Synthetic | | | 100 | | | |
| | Product 6 | | | | | | |
| | Synthetic | | | | 100 | | |
| | Product 7 | | | | | | |
| | Synthetic | | | | | 100 | |
| | Product 8 | | | | | | |
| Component (B) | TPO | | | | 2 | 2 | 2 |
| Component (C) | KBM-503 | | | | | | |
| | 14G | | | | | | |
| Film forming | YP-70 | | | | | | 5 |
| component | | | | | | | |
| Solvent | Methyl ethyl | 50 | 50 | 50 | 50 | 50 | 55 |
| | ketone | | | | | | |

| | | | | | | |
|---|---|---|---|---|---|---|
| Total | 150 | 150 | 150 | 152 | 152 | 162 |

Sheeting step
Each of the obtained stock solutions was applied, at a clearance of 200 μm, onto a release film B (AK801 manufactured by TOYOBO CO., LTD.) with a low releasability (hardly peeled) using a belt conveyor application machine. The applied stock solution was dried while passing through, at a speed of 500 mm/minute, two drying lines including a drying line having a length of 1.5 m with an atmosphere of 80° C., and a drying line having a length of 1.5 m with an atmosphere of 100° C., and a sheet-shaped composition was obtained thereby. A release film A (A31 manufactured by TOYOBO CO., LTD.) with a high releasability (easily peeled) was then bonded to the sheet-shaped composition. Each sheet-shaped composition having two types of release films, in which the release film B, the sheet-shaped composition and the release film A are laminated in this order, was prepared.

Each of the release films was compared in terms of releasability as follows.
Polyester adhesive tape No. 31B manufactured by Nitto Denko Corporation was bonded to the release treatment surface using a 2-kg roller in accordance with JIS Z0237:2009. A release strength of each of the release films was measured 30 minutes after bonding under the conditions where the release angle was 180° and the release speed was 0.3 m/minute.

As a result, the release strength of the release film A with a weak release strength was 0.05 N/25 mm. Meanwhile, the release strength of the release film B with a strong release strength was 0.16 N/25 mm.

The film thickness of the sheet-shaped composition including the release films was measured with a thickness gauge, and the thickness of the sheet-shaped composition calculated by subtracting the thicknesses of the two types of release films from the measured film thickness was 150 μm. During drying for volatilizing the solvent, since the solvent is dried from a surface, the internal solvent hardly volatilizes. Therefore, in the case where the film thickness increases, bubbles remain inside the coating film. Hence, the clearance is preferably 300 μm or less.

Using the sheet-shaped composition obtained in each of Examples 1 to 5 and Comparative Examples 1 to 6, confirmation of shape maintainability (before curing), confirmation of releasability (before curing), confirmation of transfer performance (before curing), and release strength measurement (before and after curing) were carried out. Hereinbelow, the numbers of the stock solutions in Table 1 are directly reflected to the representation in Table 2.

Confirmation of shape maintainability (before curing)
After storing the sheet-shaped composition obtained in each of Examples 1 to 5 and Comparative Examples 1 to 6 in an atmosphere of 25° C., the release film A was peeled, visual observation was carried out according to the following evaluation criteria, and results thereof were recorded in the row of “film formability” in Table 2.

The case where components were not compatible in the preparation of the stock solution was represented as “incompatible.” In the case where the film formability was rated as “poor” or “incompatible,” the confirmation of releasability (before curing), the confirmation of transfer performance (before curing), and the release strength measurement (before and after curing) were not carried out.

### Evaluation Criteria

Good: the shape can be maintained.
Poor: the shape cannot be maintained (the sheet-shaped composition attaches to the release film(s), the sheet-shaped composition gradually flows out, etc.)

### Confirmation of Releasability (Before Curing)

The release film A was peeled from the sheet-shaped composition obtained in each of Examples 1 to 5 and Comparative Examples 1 to 6, visual observation was carried out according to the following evaluation criteria, and results thereof were recorded in the row of “Release film A” in “Releasability” in Table 2.

Thereafter, the release film B was peeled from the sheet-shaped composition after peeling the release film A, visual observation was carried out according to the following evaluation criteria, and results thereof were recorded in the row of “Rrelease film B” in “Releasability” in Table 2.

In the case where the releasability was rated as “poor,” the confirmation of transfer performance (before curing), and the release strength measurement (before and after curing) were not carried out.

### Evaluation Criteria

Good: the sheet-shaped composition is peeled from the release film(s) and does not cut.
Poor: the sheet-shaped composition is not peeled from release film(s) or cuts.

### Confirmation of Transfer Performance (Before Curing)

An alkali-free glass plate having a size of 2.0 mm thick×25 mm wide×100 mm long was attached to the sheet-shaped composition after peeling the release film A, and transfer was carried out by a hot roll laminator with the roll temperature set at 25° C. Whether the sheet-shaped composition remained on the alkali-free glass plate in the case where the release film B was peeled by hand was visually confirmed, and “Transfer performance” was determined according to the following evaluation criteria. In the case where the transfer performance was rated as “poor,” the release strength measurement (before and after curing) was not carried out.

### Evaluation Criteria

Good: transfer is possible at 25° C. (the sheet-shaped composition remains.)
Poor: transfer is impossible at 25° C. (the sheet-shaped composition does not remain.)

### Release Strength Measurement (Before and After Curing)

Release strength was measured using the following adherends 1 and 2.
Adherend 1: polyethylene terephthalate (PET) having a size of 50 μm thick×25 mm wide×150 mm long (A4300 manufactured by TOYOBO CO., LTD.)

Adherend 2: cyclic olefin copolymer (COC) having a size of 2 mm thick×25 mm wide×150 mm long (TOPAS8007S-04 manufactured by POLYPLASTICS CO., LTD.)

The adherend 2 was subjected to a plasma treatment as a pretreatment to make the water contact angle less than 40°. The release film A was peeled from the sheet-shaped composition, and transfer was carried out by a hot roll laminator with the roll temperature set at 25° C. for the adherend 2 in an area of 25 mm×800 mm.

Then, the release film B was peeled, and transfer was carried out by the hot roll laminator with the roll temperature set at 25° C. for the adherent 1 to prepare a test piece used as a test piece before curing. A similar test piece was prepared and irradiated with light with an accumulated light amount of 30 kJ/m² using a mercury lamp to prepare a test piece used as a test piece after curing.
Each test piece was pulled in a direction of 180° at a tensile speed of 60 mm/minute by universal tester TENSILON, and “Release strength (N/cm) before curing” and “Release strength (N/cm) after curing” were measured.

The release strength before curing is preferably 2.0 N/cm or more, and the release strength after curing is preferably 1.0 N/cm or more.

TABLE 2

| | | Example | | | | |
|---|---|---|---|---|---|---|
| Test item | | 1 | 2 | 3 | 4 | 5 |
| Film formability | | Good | Good | Good | Good | Good |
| Releasability | Release film A | Good | Good | Good | Good | Good |
| | Release film B | Good | Good | Good | Good | Good |

| | | | | | |
|---|---|---|---|---|---|
| Transfer performance | Good | Good | Good | Good | Good |
| Release strength before curing | 23.0 | 14.7 | 9.0 | 2.8 | 4.7 |
| Release strength after curing | 4.2 | 5.8 | 3.1 | 1.6 | 5.2 |

| | | Comparative Example | | | | | |
|---|---|---|---|---|---|---|---|
| Test item | | 1 | 2 | 3 | 4 | 5 | 6 |
| Film formability | | Good | Good | Good | Poor | Good | Incompatible |
| Releasability | Release film A | Poor | Poor | Poor | — | Good | — |
| | Release film B | Poor | Poor | Poor | — | Good | — |

| | | | | | | |
|---|---|---|---|---|---|---|
| Transfer performance | — | — | — | — | Poor | — |
| Release strength before curing | — | — | — | — | — | — |
| Release strength after curing | — | — | — | — | — | — |

In the sheet-shaped composition obtained in each of Examples 1 to 5, excellent results were obtained in all aspects of the film formability, the releasability, and the transfer performance.

The release film A which is easily peeled can be firstly peeled. The release film B which is hardly peeled is then peeled. The step of peeling release films can be sequentially carried out in this way. If the both release films have nearly equal releasability, the sheet-shaped composition is pulled by the both release films and breaks.

Since the component (A) had not been crosslinked yet by radical species generated from the component (B) at the time of measuring the release strength before curing, each of the sheet-shaped compositions was soft, and the release strength was strong.
Since each of the sheet-shaped compositions (cured product in which crosslinking had already been occurred) was hard at the time of measuring the release strength after curing, the release strength was weak.

In the case where the sheet-shaped composition is peeled from an adherend at the time of transfer, the sheet-shaped composition cannot follow the adherend even after crosslinking through light irradiation, and the adherend and an object cannot be bonded. Therefore, the sheet-shaped compositions obtained in Examples 1 to 5 have good tightness against the adherend compared to the sheet-shaped compositions obtained in Comparative Examples 1 to 6 and can follow the adherend during transfer.

The present invention has been described in detail with reference to a specific embodiment. However, it would be clear to a person skilled in the art that various changes and modifications can be added thereto without departing from the spirit and scope of the present invention. The present application is based on Japanese patent application (JP2022-130982) filed on Aug. 19, 2022, and the content thereof is incorporated herein by reference.

### INDUSTRIAL APPLICABILITY

The present invention can be used in optical fields, especially for assembling a display device such as a liquid crystal display and an organic EL display. Specifically, the present invention is suitable for assembling a display element, a cover panel, a touch panel, a VR goggle, and the like into a display device and assembling an organic EL element itself and exhibits tackiness before curing. Therefore, the present invention can perform a stable transfer, and thus can also adapt to an adherend with a curved surface instead of a plane surface.

What is claimed is:

1. A photocurable composition having a sheet shape at 25° C. in an uncured state, the photocurable composition comprising:
a component (A); and
a component (B), wherein
the photocurable composition is free from a film-forming component,
the component (A) is a urethane-modified (meth)acrylate oligomer synthesized from a component (A-1), a component (A-2) and a component (A-3),
the component (A-1) is a polyol represented by the following general formula: 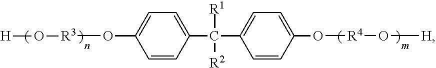
where R¹ and R² are each independently a hydrogen atom or a monovalent hydrocarbon group, R³ and R⁴ are each independently a divalent hydrocarbon group having three or more carbon atoms, and n and m are each independently an integer of 1 or more,
the component (A-2) is a polyisocyanate compound, and
the component (A-3) is a (meth)acrylate having a hydroxy group within a molecule, and
the component (B) is a photoinitiator. 25

2. The photocurable composition according to claim 1, wherein the component (A) has a weight average molecular weight of 1,000 to 50,000, and
the component (A) has 1 to 4 (meth)acryloyl groups within one molecule.

3. The photocurable composition according to claim 1, wherein the component (A-2) is an isophorone diisocyanate.

4. The photocurable composition according to claim 1, consisting of the component (A) and the component (B).

5. The photocurable composition according to claim 1, further comprising a component (C) being at least one component selected from the group consisting of a coupling agent, a (meth)acrylate monomer, and a (meth)acrylamide monomer, and consisting of the component (A), the component (B), and the component (C).

6. The photocurable composition according to claim 5, having a content of the component (C) of 0.1 parts by mass to 15 parts by mass based on 100 parts by mass of the component (A).

7. A photocurable composition comprising:
a component (A);
a component (B); and
a solvent, wherein
the component (A) is a urethane-modified (meth)acrylate oligomer synthesized from a component (A-1), a component (A-2) and a component (A-3),
the component (A-1) is a polyol represented by the following general formula: 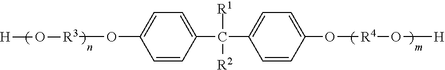
where R¹ and R² are each independently a hydrogen atom or a monovalent hydrocarbon group, R³ and R⁴ are each independently a divalent hydrocarbon group having three or more carbon atoms, and n and m are each independently an integer of 1 or more,
the component (A-2) is a polyisocyanate compound, and
the component (A-3) is a (meth)acrylate having a hydroxy group within a molecule, and
the component (B) is a photoinitiator.

8. A method for producing a photocurable composition having a sheet shape at 25° C. in an uncured state, the method comprising:
volatilizing a solvent from a photocurable composition, wherein the photocurable composition comprises:
a component (A);
a component (B); and
the solvent, wherein
the component (A) is a urethane-modified (meth)acrylate oligomer synthesized from a component (A-1), a component (A-2) and a component (A-3),
the component (A-1) is a polyol represented by the following general formula: 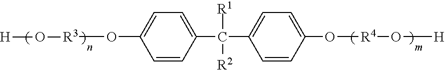
where R¹ and R² are each independently a hydrogen atom or a monovalent hydrocarbon group, R³ and R⁴ are each independently a divalent hydrocarbon group having three or more carbon atoms, and n and m are each independently an integer of 1 or more,
the component (A-2) is a polyisocyanate compound, and
the component (A-3) is a (meth)acrylate having a hydroxy group within a molecule, and
the component (B) is a photoinitiator.

9. The method according to claim 8, wherein the solvent is volatilized on a release paper or on a release film.

10. A laminated body comprising:
the photocurable composition according to claims 1; and
a release paper or a release film.
